(19) United States
(12) Patent Application Publication
(10) Pub. No.: US 2007/0253303 A1
(43) Pub. Date: Nov. 1, 2007

(54) Method for the Restitution of an Audio-Visual Work with Random Sequencing, and Corresponding Restitution Device, Computer Program and Data Medium

(76) Inventors: Bachir Kordjani, Creil (FR); Jacky Jouan, Dixmont (FR)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/629,020

(22) PCT Filed: Jun. 10, 2005
(86) PCT No.: PCT/EP05/52697

§ 371 Date: Jun. 26, 2007

(30) Foreign Application Priority Data
Jun. 11, 2004 (FR) 0406359

(51) Int. Cl. G11B 27/30

(52) U.S. Cl. 369/59.23

(57) ABSTRACT

The invention relates to a method for the restitution of an audio-visual work. According to the invention, the work is divided into sequences which are connected by nodes, whereby at least one of said nodes, known as the selection node, associates an order n sequence with at least two possible subsequent sequences of order n+1. The inventive method comprises a step involving the pseudo-random selection, for each restitution of the work and at each of the selection nodes, of one of the aforementioned possible subsequent sequences from a sub-set of authorised sequences, a subsequent sequence being authorised or denied as a function of at least one earlier selection of a sequence of order 0 to n. In this way, the work is played according to a variable, unpredictable chain of sequences, without the intervention of a spectator.

### CROSS-REFERENCE TO RELATED APPLICATION

The present application is a National State filing of and claims priority of International patent application Serial No. PCT/EP2005/052697, filed Jun. 10, 2005, and published in French.

### BACKGROUND OF THE INVENTION

The field of the invention is that of the restitution of scripted audiovisual works, and particularly films, on a terminal provided for that purpose. To be more precise, the invention relates to a new approach to such restitution, in various and variable forms.

Conventionally, a work is reproduced in a set way. Film, for example, comprises a beginning and an end, and unfolds in an absolutely linear way. The unfolding is the same if the viewer watches the same film for a second time (or more), he will see exactly the same thing with nothing new added.

In other words, the film, or another work, follows a unique preset scenario, organised for example into successive scenes or sequences. The only possible way to vary this is by pausing or fast winding in one direction or the other. But in every case, it is the same scenario (the same story) that is reproduced.

When scriptwriters have imagined that one idea could give rise to different scenarios, they have been led to create two different and independent works. These might be called alternative fictional dramas, which lead to a cinema film being produced in a number of versions varying the scenario and the direction (this is for example the case in respect of the films <<SMOKING/NO SMOKING>> by Alain RESNAIS, or the Lucas BELVAUX trilogy (Trilogy: One, Trilogy: Two, and Trilogy: Three>>). But this only allows variation that is restricted (between two versions), set and complex (since in the end two independent works are made). And the effect of surprise is lost as soon as each work has been seen once.

In other respects, interactive systems have been developed that generate interactive fictional dramas, for example in the following fields:

Educational and entertainment software using images, sound, video, etc

Computer (PC) video games, game console using computer files, memory cards or CD or DVD optical disc;

Educational CD-ROM;

DVD-ROM for randomly generated illustrated quiz games;

Interactive video film where the customer is required to select an option to find out what happens next.

The very essence of the video game consists for the player in selecting what follows next as a function of the choice offered from the different possible follow-up scenarios in the game. This is the world of interactive games. The particularity of video games is therefore that their computer program can generate conditioned or unconditioned random events which are a consequence of the action taken by the user, via the interactivity.

It is therefore no longer simply a matter of being a (passive) viewer of the work, but conversely of making choices, and transmitting them to a machine, for example by means of a keypad, a lever or a remote control.

There are furthermore random track playback generators, particularly for audio CD or DCC (digital recording on magnetic tape). The players are generally fitted with a random playback function which randomly generates the playback of a range of data among the preset group of ranges.

The same approach is sometimes available in respect of DVD or DV video players. But this function is clearly of limited interest and does not allow a work to be reproduced according to scenarios imagined by the author.

The random generation of events is based then on equally likely event selection.

Films have also been put on DVD with advertisements or short films inserted by randomly loading video format files in the buffer or direct read memory for broadcast at an identified time. But the scenarios of these advertisements or short films are set and unique, in accordance with the conventional principle stated above.

Known techniques therefore allow preset data tracks or data strings to be selected and run in a random or pseudo-random way, for example with software, image, video and sound data.

This instruction selection or execution is controlled by an inter-activity function with the public or user or pre-programmed in time.

The invention should be seen in a quite different context, in which the user is only the viewer of a work, and does not wish to interact in order to tell the machine which choices he is making.

In other words, the invention relates to the passive viewing of works, without interaction, offering the opportunity to view different versions of the works at each playback.

An approach is known, through US patent document 2003/046638, which sets out to play back digital files stored on one and the same medium with a possibility of obtaining variations randomly at each playback. This approach is based on the use of a logic tree, which fixes a series of possibilities, or alternatives.

The technical layout of this approach is not given in detail. The use of logic trees presents a number of drawbacks and limitations. It presupposes the use of read-only memory (to store the tree) and random access memory. It does not allow management of a memory effect, or of a precise notion of scenario. Indeed, it only allows, at a considered node of a tree, a choice between two or three possibilities of immediate follow-up, while a scenario presupposes a coherence relative to everything that has already happened.

### SUMMARY OF THE DESCRIPTION

The particular objective of the invention is to overcome these drawbacks of the prior art.

One objective of the invention is thus to provide a new approach to audiovisual works, and in particular to cinema films, allowing the work to be viewed several times while retaining, at least partially, an effect of surprise or suspense.

Another objective of the invention is to provide an approach of this kind without obliging the user to make choices at given moments, but on the contrary leaving him simply as a viewer.

Another objective of the invention is to provide an approach of this kind, allowing a scenario to be precisely managed in a coherent and global way and not simply to offer, at a given moment, an alternative between two sequences.

A particular objective of the invention is to allow the audiovisual work to be reproduced while retaining coherence between the scripts in each potential version.

Another objective of the invention is to provide an approach of this kind, which does not require a complex adaptation of playback devices or data supports. In particular, an objective of the invention is to provide an approach of this kind that can be implemented through software.

Yet another objective of the invention is to provide an approach of this kind, reducing complexity for filmmakers, particularly relative to the approach consisting in providing several complete films if there are a number of alternatives.

Another objective of the invention is to resolve the problem of image freezing, crucially encountered in an approach of this kind and already known in respect of interactive DVD applications that offer variations controlled by the public or user.

These objectives, and others which will emerge more clearly below, are met through the use of a method for the restitution of a scripted audiovisual work, according to which said work is cut up into sequences connected by nodes, with at least one of said nodes, so-called selection node, which associates with a sequence of order n at least two possible following sequences of order n+1. For each restitution of said work, one of said possible following sequences is selected in a pseudo-random way at each of said selection nodes, in such a way that said work unfolds in accordance with a variable and unpredictable string of sequences, with no intervention from the viewer.

One of said following sequences is selected from among a subset of authorised sequences, a following sequence being authorised or forbidden according to at least one previous selection of any order.

In this way it is possible to vary the unfolding of the work, simply and effectively, with no intervention from the viewer. This variation is not equally likely, since it takes account not only of a random choice at the current node, but also of the choices (also random) made at the previous nodes.

This allows the coherence of the selections to be controlled, relative to the scenarios, and variations in the sequence string to be reproduced with a probability specific to each of the possible combinations.

To an advantage, said sequences are selected at each node by simple mathematical tests or operations applied to registers.

A particular arrangement of the binary coding of said registers allows sequences of different order to be distinguished that cannot belong to one same sequence string. This logic rule can be programmed in low-level or high-level computer language, or using any other software that is able to perform such a function.

According to one embodiment, said sequences are numbered in accordance with a rule that allocates orthogonal codes to sequences of different order that cannot belong to one same sequence string.

In a first advantageous mode of implementation, a sequence of order n+1 is selected dynamically during playback, each time a selection node is encountered during the unfolding of said work.

According to a second advantageous mode of implementation of the invention, sequences are selected in a prior single operation in order to define said string before it begins to unfold.

In one embodiment, the method of the invention comprises a step of storing at least one already played version of said work.

This makes it possible to store a version that has been enjoyed, in order to be able to play it back, and/or to store recently played versions, in order to avoid playing them back.

To an advantage, said nodes carry a version number.

the method may then comprise a step of adding at least one sequence into a set of sequences of a previous version.

In one embodiment, the invention also provides, to an advantage, for a prior transfer and access, controlled by the coding, of at least one part of the sequence data, such as the leader of each of said sequences, into a buffer memory.

The direct playback of the leader of a selected sequence from said memory masks the time for accessing the start position of all the data in said selected sequence on the support. This embodiment of the invention ensures the quality of the digital data playback flow on a support without interruption to the restitution.

An aspect of the invention also relates to audiovisual terminals that implement the work restitution method described above. Such a terminal comprises means for selecting pseudo-randomly one of said possible following sequences at each of said selection nodes, such that said work unfolds according to a variable and unpredictable string of sequences, with no intervention from a viewer.

An aspect of the invention further relates to digital data supports for implementing the method for the restitution of a work according to the method described above. Such a support comprises at least one work cut up into sequences connected by nodes, at least one of said nodes, so-called selection node, which associates with a sequence of order n at least two possible following sequences of order n+1.

According to one embodiment, said support additionally comprises computer program elements allowing the pseudo-random selection of one of said sequences.

An aspect of the invention also relates to computer program products for the implementation of the work restitution method described above. Such a program comprises means for the selection pseudo-randomly of one of said possible following sequences at each of said selection nodes, in such a way that said work unfolds according to a variable and unpredictable sequence string, with no intervention from a viewer.

### BRIEF DESCRIPTION OF THE DRAWINGS

Other aspects and advantages of the invention will emerge more clearly from reading the following description of one preferential embodiment of the invention, given purely as an illustrative example and non-restrictively, and of the appended drawings. FIG. 1A shows a digital data frame of conventional type, and FIG. 1B a digital data frame according to an embodiment of the invention, comprising a node code;

FIG. 2 shows the structure of the code node of the frame in FIG. 1B.

FIG. 3 is a simplified flow chart of an example of determination of the node codes in FIG. 2.

FIG. 4 is a detailed example of the chaining bits of a node according to an embodiment of the invention.

FIG. 5 is a flow chart illustrating the implementation of the method of the invention, according to an embodiment.

FIG. 6 shows an example of a logic of possibility for the playback of sequences, or chapters.

FIG. 7 is an example of node name bit allocation, for the architecture in FIG. 6.

FIG. 8 shows the adding of chapters to the logic in FIG. 6, for example in the context of a subsequent version.

FIG. 9 shows the name bits for the architecture in FIG. 8, according to the principle in FIG. 7.

FIG. 10 shows a particular example of a logic of possibility for sequence playback.

### DETAILED DESCRIPTION

Aspects of the invention relate to a new and inventive approach to the structure of audiovisual work scenarios, and on the technical means allowing it to be implemented. In a simplified way, these techniques are twofold:

a scenario structure offering at certain times multiple possibilities for the following sequence, stored in a coded way on the data support and/or in the restitution terminal;

means for the random selection of a following sequence, from among several available sequences.

In this way, the playback of a scenario is no longer linear or unique. When he starts to view a work, the viewer cannot know exactly how the work he is going to see will unfold, even if he has already seen it. The end, or an intermediate part, may change, randomly, while retaining a scripted coherence (which presupposes that each choice, although random, takes account of all previous choices, also random, in accordance with the overall scenario and possible alternatives thereof, as defined by the scriptwriter), with no intervention from the user.

A work is thus obtained with multiple scenarios, and the terminals simply select the concatenation of the sequences automatically and randomly (pseudo-randomly).

In other words, the system proposes a pseudo-random generation of the playback of digital data recorded on supports provided for that purpose, such as optical discs (CD-ROM, DVD, etc), magnetic tapes (DV, DCC, etc), EEPROM microelectronic memory cards or the like, or computer hard disks (possibly on remote servers).

The system therefore makes it possible to generate a sequence of events, such as the playback of video data, in such a way that these events follow each other, preferentially according to a preset logic of acceptance and prohibition, and that each of these events is selected randomly from among a set of possibilities compatible with said logic.

In this way, digital data stored on a medium compatible with a machine equipped with an electronic microprocessor is played back, according to a pseudo-random programming of data sequences, automatically, with no intervention from the user, generated by the machine.

Additionally, aspects of the invention offers possibilities for developing the logic and quantity of data offered to the pseudo-random selection.

The programming of a succession of sequences, known as a chain, is therefore generated, with no notion of interactivity, in a pseudo-random way. To do this, at the end of a sequence n, a sequence n+1 is selected from a <<sub-list>> of authorised sequences n+1, this <<sub-list>> being extracted from a list of possible sequences n+1, from which the forbidden sequences n+1 according to the sequences 1 to n which have previously been selected, are removed.

For example, if a character dies in one of the previous sequences 1 to n, none of the sequences n+1 in which this person appears must be used, and are therefore forbidden.

In this way, different versions can be generated of one and the same cinema film recorded in digital format. The different versions may particularly correspond to various scenarios or arrangements of scenes with potentially different probabilities of occurrence. The cinematographic work, or film, is produced and directed with the intention of using this pseudo-random playback technique.

The film can then be reproduced on the screen in such a way that, each time the playback procedure is activated, the user does not necessarily view exactly the same film. The possible alternatives generated pseudo-randomly are of course those authorised by the design of the film. They can in particular be the result of different scenes provided in addition to or as an alternative to others so as to create different possible scenarios.

In this way, the user is never sure he will see one and the same scene frame each time he runs the recorded film.

Aspects of the invention may in particular be applied to the following systems:

Digital file playback systems (computers and all DVD, CD, DVX, DV, DCC, players etc);

Video films recorded using digital data (DVD, DV, DVX, etc);

Videos for video games;

Video (or audio or text) support for training that require a notion of scenario in the constitution of a series of events (or exercises,) the pseudo-random arrangement of which constitutes a particular educational tool (telephone interview, flight simulator, etc);

More generally, in all fields able to use a logical or sequenced succession with a (scripted) notion of ordering events.

A particular embodiment will now be described in more detail, consisting in playing back, using the principle described, a film provided for this purpose from a digital recording.

This digital recording can be made on the hard disk of a computer or another support like a DVD disc. Playback occurs by means of an existing tool such as MPEG decoder software and a computer or a DVD disc playback machine.

The film is constituted by a series of scenes unfolding one after the other logically with between each scene a node. The node gives the system the opportunity to produce pseudo-randomly the following scene selected from a list of authorised scenes.

In a general way, the system implements digital processing, managing the order of appearance and the selection of sequences at each node according to the stated method. This computer processing may, where appropriate, be assisted by audiovisual work design and editing software or encoded in machine language for the restitution device.

At least one vector space is defined of dimensions corresponding to the information needed for the coherent restitution of the sequences. A sequence is represented by a vector in this space. The authentication code of each sequence corresponds to the projection of this vector in each of the dimensions. These dimensions can for example correspond to the following elements:

Position in the film;

Compatibility with the previous scene n−1;

Compatibility a with the previous scene n−2;

Compatibility a with the scene 0;

Version of the film;

Effect of surprise (to avoid replaying an identical scenario or one close to the one previously viewed);

. . .

The concatenation of sequences for a particular restitution is achieved by simple mathematical operations applied to binary projections in each of the dimensions.

In one particular embodiment, the recording on the support contains all the scenes of one and the same film and all possible alternatives thereof. A conventional scene is presented in the form shown in FIG. 1. It comprises a digital data frame 11 preceded by an identification code 12 in binary in the form of a series of bits. This code is generally used to identify the chapter number of each recorded scene, on a DVD disc for example, allowing the playback system to locate them on the support.

Such a frame is completed as illustrated in FIG. 1B. Additional bits 13 are inserted, so-called <<node code>>. A binary program can then be used to give a link to each scene with the nodes at which it is authorised.

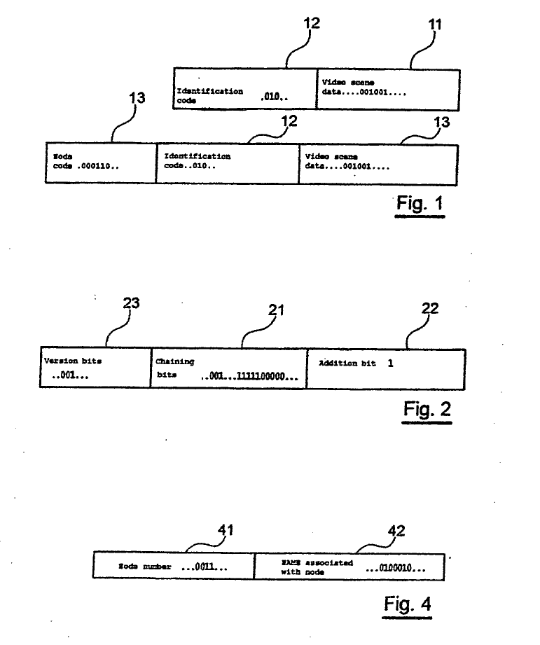

This node code is shown in FIG. 2. The node code for each scene is defined notably with <<chaining bits>> 21, such that the program selects a list of authorised scenes at each node from all the scenes recorded on the support.

The code 21 for the nodes is judiciously allocated beforehand (for example using orthogonal codes), so as to cancel the products of the codes in order to signify that the corresponding scenes are forbidden.

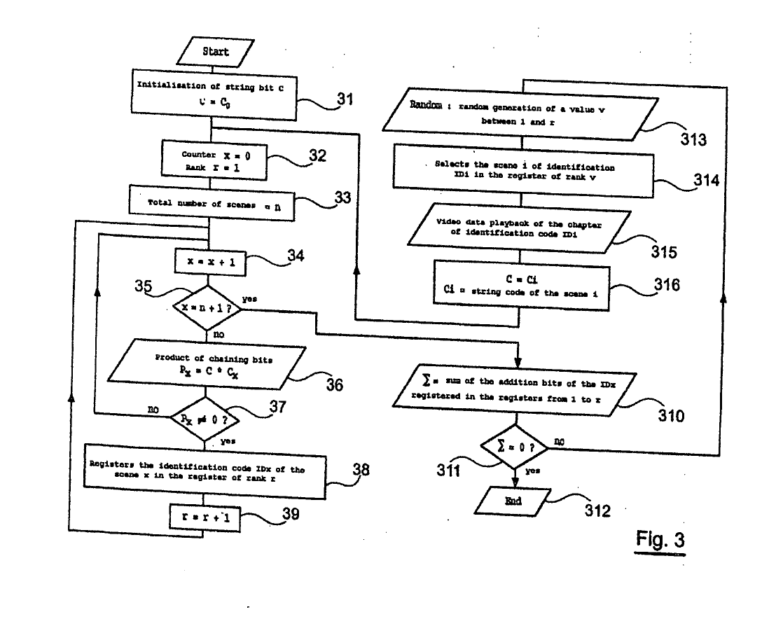

For each node of the film, a program, illustrated in FIG. 3, carries out simple operations, such as multiplication (bit by bit), between the chaining bits of the node code of the scene preceding the node and the node codes of all the recorded scenes. The results of these operations, not nil for example, identify the authorised scenes.

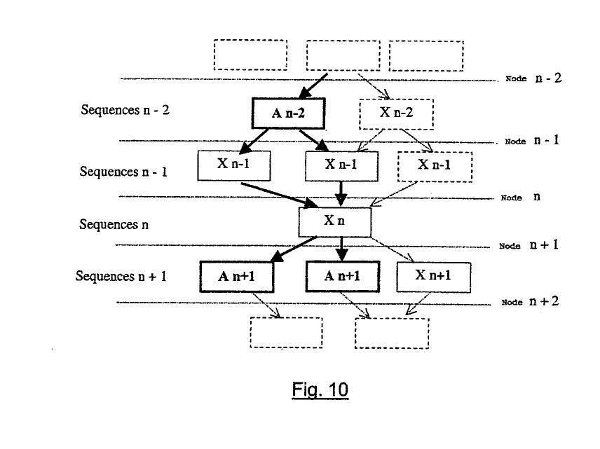

The selection of the next authorised sequences of order n+1 at each node of order n can then be completed by at least one condition such as for example the prohibition from selecting a sequence of order n+1 according to a prior selection of at least one sequence of order 0 to n. This aspect is shown in FIG. 10, described in more detail below.

The program then counts all the authorised scenes at each node, for example by addition of a bit, known as an addition bit 22 (FIG. 2) of the node code set systematically at 1. The random generation function of the system is then used by example to generate a value between 1 and the total number of authorised scenes. The value generated determines the scene which is to be played and so on at each node.

To be more precise, the program comprises program means in order to implement the following operations:

Initialisation 31 of a chain bit C at the value C₀;

Initialisation 32 of a counter x at 0 and a rank value r at 1;

Initialisation 33 of the total number of scenes n;

Incrementation 34 of the scene counter x;

If (35) x is different from n+1:

Product 36 of the chaining bits: Pₓ=C*Cₓ;

If (37) Pₓ is nil, return to step 34, otherwise:
Recording 38 of an identification code IDₓ of the scene x in a register r;
Incrementation 39 of the value of r;
Return to step 34;

Otherwise (35):
Summation 310 of the addition bits in IDₓ recorded in the registers from 1 to r;
If (311) the sum is nil: end 312, otherwise:
Random generation 313 of a value v between 1 and r;
Selection 314 of scene i of identification code IDᵢ in the register of rank v;
Playback 315 of the video data of the chapter of identification code IDᵢ;
Setting 316 of the values C=Cᵢ and Cᵢ=chain code of the scene i;
Return to step 32.

The node code can be completed by bits 23 identifying the version of the complete film allowing subsequent developments of the work by the addition of scenes, scenarios and arrangements of additional scenes. These version bits will actually make it possible to multiply the possibilities of arrangement between the additional scenes and those already existing in the previous version. This will make it necessary to change or adapt the new codification relative to the old one.

As shown in FIG. 4, the chaining bits make it possible to encode the node number 41 to which the data frame belongs and a name 42 which is associated with it. This name can be selected judiciously for each data frame, corresponding to a video chapter of the film, so as to authorise or prohibit the concatenation of the next chapters.

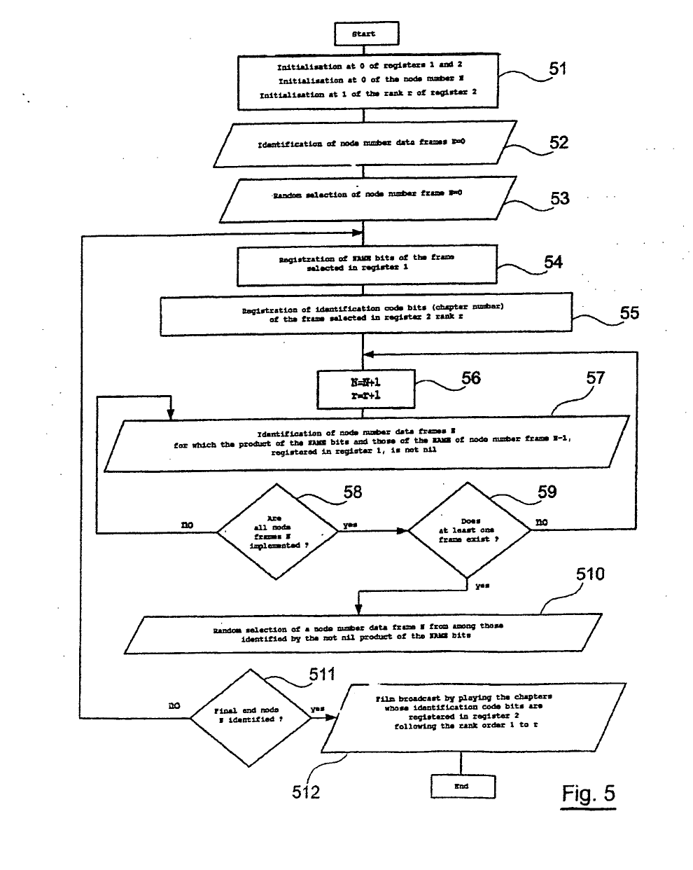

In a general way, the logic of the pseudo random generation of the video chapters of a film, illustrated by the algorithm in FIG. 5, uses these names to perform operations such as the product of the name bits of all the data frames of one and the same node number and the name bits of the data frame selected at the previous node.

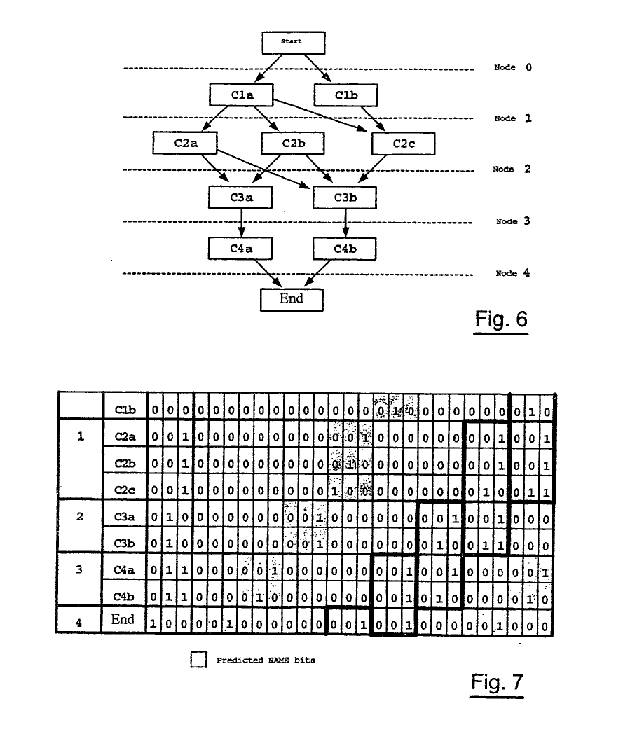

The purpose is to generate a film in a random way in the form of a concatenation of video chapters, from among all possible arrangements. FIG. 6 shows an example of the arrangement of these video chapters recorded on the support. The concatenation must respect rules of authorisation or prohibition between some of these chapters for a proper coherence of the filmed work.

A method that can be used is the choice of using orthogonal codes for the names of the data frames of which the chapters cannot follow each other in the final unfolding of the film, as shown in FIG. 7.

At each node following a chapter selection, the name of this chapter is multiplied by the names of all the recorded chapters that have the current node number. A judicious choice of NAME bits orthogonal to each other, when the chapters they identify are not authorised to follow each other in the recording, allows the automatic programming of the film described in FIG. 7.

If the result of the product is not nil, then the chapter implemented is selected from a stack as a candidate for the selection of the following chapter and the system performs the operation on the chapter of the next current node number. If the result of the product is nil, on account of the choice of orthogonal codes, the chapter implemented is not retained and the system performs the operation on the chapter of the next current node number.

This logic makes it possible to generate pseudo-random automatic programming, as shown in FIG. 5, of the video chapters to be played back by the machine.

In this FIG. 5, the following steps have been shown:

Initialisation 51 at 0 of two registers numbered 1 and 2, and of the node number N, and initialisation at 1 of the rank r of the register 2;

Identification 52 of the node number data frames N=0;

Random selection 53 of a node number frame N=0;

Recording 54 of the name bits of the frame selected in the register 1;

Recording 55 of the identification code bits (chapter number) of the frame selected in the register 2 at the rank r;

Incrementation 56 of N and r;

Identification 57 of the node number data frames N of which the product of the NAME bits by those of the NAME of the node number frame N-1, recorded in the register 1 is not nil;

If (58) all the node frames N are not processed, return to step 57, otherwise:

If (59) there are no other frames, return to step 56, otherwise:

Random selection (510) of a node number data frame N from among those identified by the not nil product of the NAME bits;

If (511) it is the last node N:
Broadcast (512) of the film by playing the chapters the identification code bits of which are recorded in the register 2 following the order of the ranks 1 to r;

Otherwise, return to step 54.

In the example shown in FIG. 6 and 7, after the random node selection 0 between the chapters C1a and C1b, the system multiplies the name bits of the chapters of node 1 by the name bits of the chapter of node 0 already selected. The C1b name bits are encoded orthogonally to those of C2a and C2b so as to prohibit the identification of these chapters following C1b, whereas the product with the name bits of chapter C2c gives a not nil result. Thus only chapter C2c may follow chapter C1b.

The C1a name bits are encoded so that the result of their multiplication with the name bits of all the chapters C2a, C2b and C2c of node 1 is not nil. In this way any one of the three chapters C2a, C2b or C2c may follow the chapter C1a. One of them must be selected randomly.

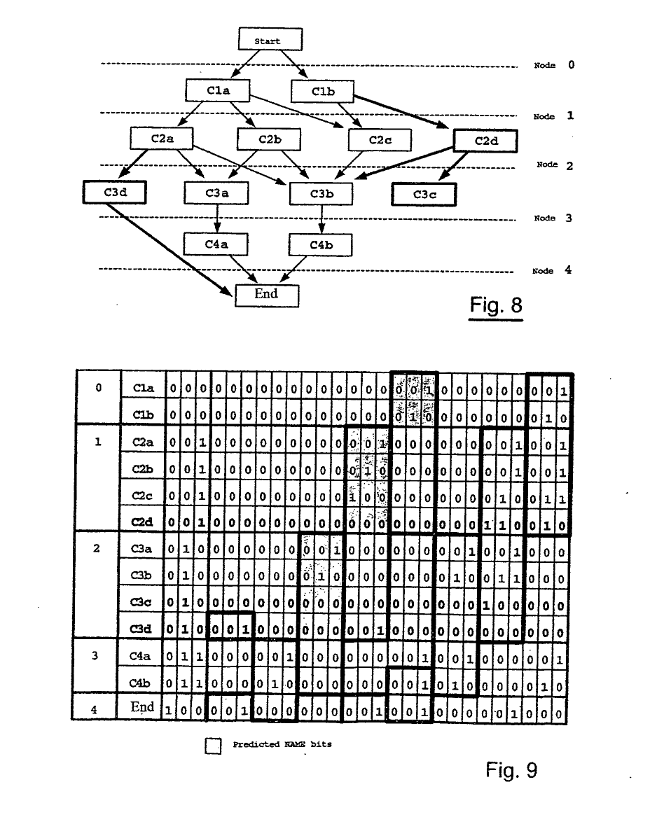

The use of some predicted name bits (predicted bits greyed out in the figure) makes it possible to give references for future versions of the film or new chapters may be inserted as well as chaining links with old and new chapters, as shown in FIG. 8. In this FIG. 8, the chapters C2d, C3c, C3d have been added during a subsequent version of the film in FIG. 6.

The predicted bits can be used to encode judiciously the name bits of the new chapters, as shown in FIG. 9, in the case where the number of bits used initially does not allow sufficient arrangement between the old and new chapters. The predicted NAME bits (greyed out in the figure) are used to concatenate the additional chapters of the subsequent version in FIG. 8.

As a last resort, if the number of arrangements required by the new version is too high, the system can use the version bits (FIG. 2), of each data frame to demultiply the possible codifications.

Several alternatives of the invention are of course conceivable.

It is thus possible, particularly in the case of DVDs, to encode the acceptance and prohibition rules in an execution script during the selection of a sequence of order n+1 at a node following a sequence of order n, by using binary registers known as GPRM encoded over 16 bits and simple functions provided by the DVD standard such as for example:

RANDOM VALUE GENERATION (RAND)

GO TO

IF THEN ELSE

COMPARISON (>,<,=,< >, etc)

ADDITION, SUBTRACTION, MULTIPLICATION etc

The invention is then implemented in the form of one or more rules laid down in a language specific to the DVD design and editing software used.

Another alternative of the invention is to pre-configure all possible sequence strings in advance and to record this list of strings (or pre-programming playback ranges) on the digital support, so as to be able to use the existing <<RANDOM>> selection function on the data readers, associating with it a weighting system specific to the probability of occurrence of each string so as to select one of these strings pseudo randomly. The string selected is then identified as the programming of successive ranges to be read by the system.

This alternative is not however optimum for the quantity of data to be stored on the support, and does not facilitate the possibilities of expanding the quantity of this data and the playback logic thereof.

FIG. 10 shows a particular example of a logic of possibilities of sequence playback with the prohibition on selecting a part of the sequences n+1 following a node of order n subsequent to a prior selection of a sequence of order lower than n. For example the selection of a sequence A of order n-2 induces the selection at the node of order n of a sequence of order n+1 among an authorised subset of sequences A of order N+1.

In this way, the fact that the sequence An-2 101 has been chosen previously as the sequence to be viewed (and not the sequence of same order 102) means that, at the moment of selecting the sequence of order n+1, the choice is restricted to the two sequences An+1 103 and 104, whereas, seen from the sequence Xn 105, three possibilities are open, with additionally the sequence Xn+1 106.

In other words, the previous sequences (in the event the sequence n-2) induce a constraint, or marking, defining the possible follow-ups, in accordance with the coherence of the scenario. In this way, there is an (at least) double random level, and therefore a not equally likely distribution of choices.

1. A method for the restitution of an audio-visual work according to which said work is cut up into sequences connected by nodes, with at least one of said nodes, so-called selection node, which associates with a sequence of order n at least two possible following sequences of order n+1:
wherein that it comprises a step of pseudo-random selection, for each restitution of said work and at each of said selection nodes, one of said possible following sequences from among a subset of authorized sequences, a following sequence being authorized or forbidden according to at least one previous selection of a sequence of order 0 to n;
in such a way that said work unfolds in accordance with a variable and unpredictable string of sequences, with no intervention from a viewer.

2. The method for the restitution of a work according to claim 1, wherein that with each of said sequences and/or with each of said nodes is associated at least one binary register of selection information;
and in that said selection step implements at least one mathematical operator applied to at least one of said registers.

3. The method for the restitution of a work according to claim 2, wherein that said mathematical operators belong to the group comprising:
random value generation instructions;
direction instructions (<<GO TO>>);
condition test instructions;
comparison instructions;
addition, subtraction, multiplication instructions.

4. The method for the restitution of a work according to claim 1, wherein that said sequences are numbered in accordance with a rule that allocates orthogonal codes to sequences of different order that cannot belong to one same sequence string.

5. The method for the restitution of a work according to claim 2, wherein that each of said registers contains one of said orthogonal codes.

6. The method for the restitution of a work according to claim 1, wherein that a sequence of order n+1 is selected as and when the need arises, each time a selection node is encountered during the unfolding of said work.

7. The method for the restitution of a work according to claim 1, wherein that sequences are selected in a prior single operation in order to define said string before it begins to unfold.

8. The method for the restitution of a work according to claim 1, wherein that it comprises a step of storing at least one already played version of said work.

9. The method for the restitution of a work according to claim 1, wherein that said nodes carry a version number and that it comprises a step of adding at least one sequence in a set of sequences of a previous version.

10. The method for the restitution of a work according to claim 1, wherein that it comprises, during the restitution of a sequence of order n, a step of prior storing in a buffer memory of at least one part of the data of each of the authorised sequences of order n+1, so as to mask the time for acquiring the data of the selected sequence of order n+1.

11. Audio-visual terminal implementing the method for the restitution of a work according to claim 1, wherein that it comprises means for the pseudo-random selection of one of said possible following sequences at each of said selection nodes, according to at least one previous selection of a sequence of order 0 to n, in such a way that said work unfolds in accordance with a variable and unpredictable string of sequences, with no intervention from a viewer.

12. Digital data support for the implementation of the method for the restitution of a work according to claim 1, wherein that it comprises at least one work cut up into sequences connected by nodes, with at least one of said nodes, so-called selection node, which associates with a sequence of order n at least two possible following sequences of order n+1 and information defining authorized and prohibited sequences according to at least one previous selection of a sequence of order 0 to n.

13. Digital data support according to claim 12, wherein that it additionally comprises computer program elements allowing the pseudo-random selection of one of said sequences.

14. Computer program product for the implementation of the method for the restitution of a work according to claim 1, wherein that it comprises means for the pseudo-random selection of one of said possible following sequences at each of said selection nodes, according to at least one previous selection of a sequence of order 0 to n, in such a way that said work unfolds in accordance with a variable and unpredictable string of sequences, with no intervention from a viewer.
